(19) United States
(12) Patent Application Publication
(10) Pub. No.: US 2007/0109267 A1
(43) Pub. Date: May 17, 2007

(54) Speckle-based two-dimensional motion tracking

(75) Inventors: Li Guo, Hefei (CN); Tian Qiu, Hefei (CN); Donghui Li, Hefei (CN); Jun Liu, Hefei (CN); Yuan Kong, Kirkland, WA (US)

Correspondence Address: BANNER & WITCOFF, LTD.;ATTORNEYS FOR CLIENT NOS. 003797 & 013797, 1100 13th STREET, N.W., SUITE 1200, WASHINGTON, DC, 20005-4051, US

(73) Assignee: Microsoft Corporation, Redmond, WA (US)

(21) Appl. No.: 11/272,403

(22) Filed: Nov. 14, 2005

(51) Int. Cl. G09G 5/08

(52) U.S. Cl. 345/166

(57) ABSTRACT

Reflected laser light having a speckle pattern is received in a pixel array. Pixel outputs are combined into series representing pixel intensities along particular dimensions at times t and t+Δt. Centroids for each series can be identified, and vectors determined for movement of centroids from time t to time t+Δt. Crossing points may alternatively be identified for data within each series relative to a reference value for that series, and vectors determined for movement of crossing points from time t to time t+Δt. A probability analysis may be used to extract a magnitude and direction of array displacement from a distribution of movement vectors. A series of data values corresponding to time t+Δt may alternatively be correlated to advanced and delayed versions of a series of data values corresponding to time t. The highest correlation is then used to determine movement.

### BACKGROUND

Measuring motion in two or more dimensions is extremely useful in numerous applications. Computer input devices such as mice are but one example. In particular, a computer mouse typically provides input to a computer based on the amount and direction of mouse motion over a work surface (e.g., a desk top). Many existing mice employ an imaging array for determining movement. As the mouse moves across the work surface, small overlapping work surface areas are imaged. Processing algorithms within the mouse firmware then compare these images (or frames). In general, the relative motion of the work surface is calculated by correlating surface features common to overlapping portions of adjacent frames.

These and other optical motion tracking techniques work well in many circumstances. In some cases, however, there is room for improvement. Some types of surfaces can be difficult to image, or may lack sufficient surface features that are detectable using conventional techniques. For instance, some surfaces have features which are often undetectable unless expensive optics or imaging circuitry is used. Systems able to detect movement of such surfaces (without requiring expensive optics or imaging circuitry) would be advantageous.

The imaging array used in conventional techniques can also cause difficulties. In particular, conventional imaging techniques require a relatively large array of light-sensitive imaging elements. Although the array size may be small in absolute terms (e.g., approximately 1 mm by 1 mm), that size may consume a substantial portion of an integrated circuit (IC) die. Reduction of array size could thus permit reduction of overall IC size. Moreover, the imaging elements (or pixels) of conventional arrays are generally arranged in a single rectangular block that is square or near-square. When designing an integrated circuit for an imager, finding space for such a large single block can sometimes pose challenges. IC design would be simplified if the size of an array could be reduced and/or if there were more freedom with regard to arrangement of the array.

Another challenge posed by conventional imaging techniques involves the correlation algorithms used to calculate motion. These algorithms can be relatively complex, and may require a substantial amount of processing power. This can also increase cost for imaging ICs. Motion tracking techniques that require fewer and/or simpler computations would provide an advantage over current systems.

One possible alternative motion tracking technology utilizes a phenomenon known as laser speckle. Speckle, which results when a surface is illuminated with a coherent light source (e.g., a laser), is a granular or mottled pattern observable when a laser beam is diffusely reflected from a surface with a complicated structure. Speckling is caused by the interference between different portions of a laser beam as it is reflected from minute or microscopic surface features. A speckle pattern from a given surface will be random. However, for movements that are small relative to spot size of a laser beam, the change in a speckle pattern as a laser is moved across a surface is non-random. Several approaches for motion detection using laser speckle images have been developed. However, there remains a need for alternate ways in which motion can be determined in two dimensions through use of images containing speckle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In at least some embodiments, a relatively moving surface is illuminated with a laser. Light from the laser is reflected by the surface into an array of photosensitive elements; the reflected light includes a speckle pattern. A series of data values is calculated at a time t for each of multiple dimensions. Another series is then calculated for each dimension at time t+Δt. Each of these series represents a range of pixel intensities along a particular dimension of the array at time t or at time t+Δt. Each series can be, e.g., sums of outputs for pixels arranged perpendicular to a dimension along which motion is to be determined. Various techniques may then be employed to determine motion of the array based on the series of data values. In at least some embodiments, centroids corresponding to portions of the data within each series are identified. Movement vectors in each dimension are then determined for movement of centroids from time t to time t+Δt. A probability analysis may be used to extract a magnitude and direction of array displacement from a distribution of such movement vectors.

In other embodiments, crossing points are identified for data within each series relative to a reference value for that series. Movement vectors in each dimension are then determined for movement of crossing points from time t to time t+Δt. A probability analysis may also be used with this technique to extract magnitude and direction of array displacement. In still other embodiments, a series of data values corresponding to pixel outputs along a particular dimension at time t+Δt is correlated to multiple advanced and delayed versions of a series of data values corresponding to pixel outputs along that same dimension at time t. The highest correlation is then used to identify the value for advancement or delay indicative of array movement in that dimension.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a computer mouse according to at least one exemplary embodiment.

FIG. 2 is a partially schematic block diagram of an integrated circuit of the mouse in FIG. 1.

FIG. 3 is a partially schematic diagram of an array in the mouse of FIG. 1.

FIGS. 4A through 4D are curves explaining motion calculation according to at least some exemplary embodiments.

FIG. 5 shows the curve of FIG. 4A superimposed on the curve of FIG. 4B.

FIGS. 6A through 6D are curves explaining motion calculation according to at least some other exemplary embodiments.

FIG. 7 shows the curve of FIG. 6A superimposed on the curve of FIG. 6B.

FIGS. 8A through 8C are curves explaining motion calculation according to at least some additional exemplary embodiments.

FIG. 9 shows a computer mouse according to at least one other exemplary embodiment.

FIG. 10 is a partially schematic diagram of an array in the mouse of FIG. 9.

FIGS. 11A and 11B show arrangements of pixels in arrays according to other embodiments.

FIGS. 12A and 12B show an arrangement of pixels according to another embodiment.

FIGS. 13 through 15C are flow charts showing algorithms for calculating motion according to at least some exemplary embodiments.

### DETAILED DESCRIPTION

Various exemplary embodiments will be described in the context of a laser speckle tracking system used to measure movement of a computer mouse relative to a desk top or other work surface. However, the invention is not limited to implementation in connection with a computer mouse. Indeed, the invention is not limited to implementation in connection with a computer input device.

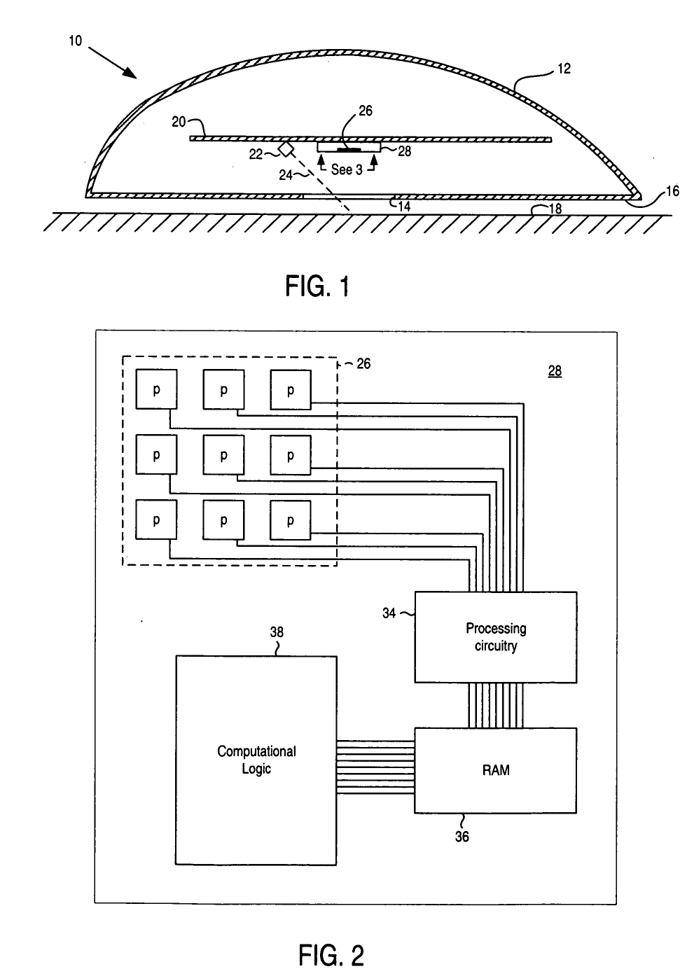

FIG. 1 shows a computer mouse 10 according to at least one exemplary embodiment. Computer mouse 10 includes a housing 12 having an opening 14 formed in a bottom face 16. Bottom face 16 is movable across a work surface 18. For simplicity, a small space is shown between bottom face 16 and work surface 18 in FIG. 1. In practice, however, bottom face 16 may rest flat on surface 18. Located within mouse 10 is a printed circuit board (PCB) 20. Positioned on an underside of PCB 20 is a laser 22. Laser 22 may be a vertical cavity surface emitting laser, an edge emitting laser diode or some other type of coherent light source. Laser 22 directs a beam 24 at a portion of surface 18 visible through opening 14. Beam 24, which may include light of a visible wavelength and/or light of a non-visible wavelength, strikes surface 18 and is reflected into an array 26 of a motion sensing integrated circuit (IC) 28. Because of speckling, the light reaching array 26 has a high frequency pattern of bright and dark regions. Because of this high frequency pattern, the intensity of light falling on different parts of array 26 will usually vary. As mouse 10 moves across surface 18, changes in the pattern of light received by array 26 are used to calculate the direction and amount of motion in two dimensions.

FIG. 2 is a partially schematic block diagram of IC 28. Array 26 of IC 28 includes a plurality of pixels p. Each pixel p may be a photodiode or other photosensitive element which has an electrical property that varies in relation to the intensity of received light. For simplicity, only nine pixels are shown in FIG. 2. As discussed below, however, array 26 may have many more pixels, and those pixels may be arranged in a variety of different ways. At multiple times, each pixel outputs a signal (e.g., a voltage). The raw pixel output signals are amplified, converted to digital values and otherwise conditioned in processing circuitry 34. Processing circuitry 34 then forwards data corresponding to the original pixel output signals for storage in RAM 36. Computational logic 38 then accesses the pixel data stored in RAM 36 and calculates motion based on that data. Because numerous specific circuits for capturing values from a set of photosensitive pixels are known in the art, additional details of IC 28 are not included herein. Notably, FIG. 2 generally shows basic elements of circuitry for processing, storing and performing computations upon signals obtained from an array. Numerous other elements and variations on the arrangement shown in FIG. 2 are known to persons skilled in the art. For example, some or all of the operations performed in processing circuitry 34 could be performed within circuit elements contained within each pixel. The herein-described illustrative embodiments are directed to various arrangements of pixels and to details of calculations performed within computational logic 38. Adaptation of known circuits to include these pixel arrangements and perform these calculations is within the routine abilities of persons of ordinary skill in the art once such persons possess the information provided herein.

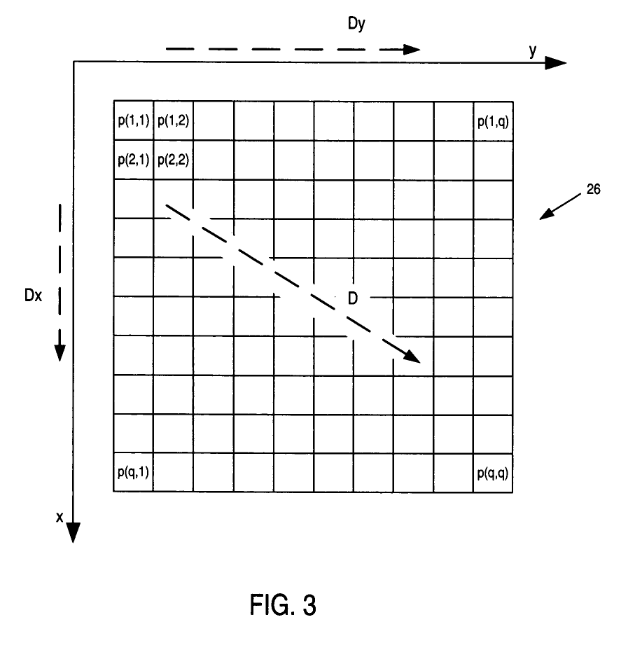

FIG. 3 is a partially schematic diagram of array 26 taken from the position indicated in FIG. 1. For convenience, pixels in array 26 are labeled p(r,c) in FIG. 3, where r and c are (respectively) the indices of the row and column where the pixel is located relative to the x and y dimensions. In the illustrative embodiment of FIGS. 1 through 3, array 26 is a q by q array, where q is an integer. The unnumbered squares in FIG. 3 correspond to an arbitrary number of additional pixels. In other words, and notwithstanding the fact that FIG. 3 literally shows a ten pixel by ten pixel array, q is not necessarily equal to ten in all embodiments. Indeed, array 26 need not be square. In other words, array 26 could be a q by q′ array, where q≠q′.

Data based on output from pixels in array 26 is used to calculate motion in the two dimensions shown (i.e., the x and y dimensions). Superimposed on array 26 in FIG. 3 is an arrow indicating a possible direction in which surface 18 (see FIG. 1) might move relative to array 26 from time t to time t+Δt. That motion has an x-dimension displacement component Dx and a y-dimension displacement component Dy. In order to calculate the x-dimension displacement Dx, the data based on pixel outputs at time t from each x row are condensed to a single value. The data based on pixel outputs from each x row at time t+Δt are also condensed. In particular, the pixel data for each row is summed according to Equations 1 and 2.
Sxₜ(r)=Σ_{c=1}^{q}pixₜ(r,c), for r=1, 2, . . . q Equation 1
Sx_{t+Δt}(r)=Σ_{c=1}^{q}pix_{t+Δt}(r,c), for r=1, 2, . . . q Equation 2

In Equation 1, “pixₜ(r, c)” is data corresponding to the output at time t of the pixel in row r, column c of array 26. The quantity “pix_{t+Δt}(r,c)” in Equation 2 is data corresponding to the output at time t+Δt of the pixel in row r, column c of array 26. If array 26 was instead an x=q by y=q′ array (where q≠q′), the summation in Equations 1 and 2 would be from 1 to q′.

In order to calculate the y-dimension displacement Dy, the pixel data based on pixel outputs from each y column are similarly condensed to a single value for time t and a single value for time t+Δt, as set forth in Equations 3 and 4.
Syₜ(c)=Σᵣ₌₁^{q}pixₜ(r,c), for c=1, 2, . . . q Equation 3
Sy_{t+Δt}(c)=Σᵣ₌₁^{q}pix_{t+Δt}(r, c), for c=1, 2, . . . q Equation 4

As in Equations 1 and 2, “pixₜ(r,c)” and “pix_{t+Δt}(r,c)” in Equations 3 and 4 are data corresponding to the outputs (at times t and time t+Δt, respectively) of the pixel in row r, column c. If array 26 was instead an x=q by y=q′ array (where q≠q′), Equations 3 and 4 would instead be performed for c=1, 2, . . . q′.

Images from array 26 at times t and t+Δt will thus result in four series of condensed data values. The series X(t) includes the values {Sxₜ(1), Sxₜ(2), . . . , Sxₜ(q)} and represents a range of pixel intensities along the x dimension of array 26 at time t. The series X(t+Δt) includes the values {Sx_{t+Δt}(1), Sx_{t+Δt} (2), . . . , Sx_{t+Δt}(q)} and represents a range of pixel intensities along the x dimension at time t+Δt. The series Y(t) includes the values {Syₜ(1), Syₜ(2), . . . , Syₜ(q)} and represents a range of pixel intensities along the y dimension of array 26 at time t. The series Y(t+Δt) includes the values {Sy_{t+Δt}(1), Sy_{t+Δt}(2), . . . , Sy_{t+Δt}(q)} and represents a range of pixel intensities along the y dimension at time t+Δt. If array 26 was instead an x=q by y=q′ array (where q≠q′), the series Y(t) would include the values {Syₜ(1), Syₜ(2), . . . , Syₜ(q′)} and the series Y(t+Δt) would include the values {Sy_{t+Δt}(1), Sy_{t+Δt}(2), . . . , Sy_{t+Δt}(q′)}. For simplicity, the remainder of this description will primarily focus upon embodiments where the X(t) and X(t+Δt) series and the Y(t) and Y(t+Δt) have the same number of data values. However, this need not be the case. Persons skilled in the art will readily appreciate how the formulae described below can be modified for embodiments in which the X(t) and X(t+Δt) series each contains q data values and the Y(t) and Y(t+Δt) series each contains q′ data values.

In at least some embodiments, additional preprocessing is performed upon these four series before calculating Dx and Dy between times t and t+Δt. For example, data values within a series may be filtered in order to reduce the impact of noise in the signals output by the pixels of array 26. This filtering can be performed in various manners. In at least some embodiments, a k rank filter according to the transfer function of Equation 5 is used.

$$H ( z ) = \frac{1 + {z}^{- 1} + {z}^{- 2} ++ {z}^{- 3} + … + {z}^{1 - k}}{k} , where k = 1 , 2 , 3 , … \qquad Equation 5$$

The filter of Equation 5 is applied to a data value series (“Series( )”) to obtain a filtered data series (“SeriesF( )”) according to Equation 6.
SeriesF( )=H(z)\textcircled{x}Series( ) Equation 6

After filtering in accordance with Equations 5 and 6, the series X(t), X(t+Δt), Y(t) and Y(t+Δt) respectively become XF(t) (=H(z)\textcircled{x}X(t)), XF(t+Δt) (=H(z)\textcircled{x}X(t+Δt)), YF(t) (=H(z)\textcircled{x}Y(t)) and YF(t+Δt) (=H(z)\textcircled{x}Y(t+Δt)), as set forth in Table 1.

TABLE 1

| Data Series before Filtering | Data Series after Filtering |
|---|---|
| X(t) = {Sxₜ(1), Sxₜ(2), . . . , Sxₜ(q)} | XF(t) = {SFxₜ(1), SFxₜ(2), . . . , |
| | SFxₜ(q)} |
| X(t + Δt) = {Sx_{t+Δt}(1), | XF(t+Δt) = {SFx_{t+Δt}(1), |
| Sx_{t+Δt}(2), . . . , Sx_{t+Δt}(q)} | SFx_{t+Δt}(2), . . . , SFx_{t+Δt}(q)} |
| Y(t) = {Syₜ(1), Syₜ(2), . . . , Syₜ(q)} | YF(t) = {SFyₜ(1), SFyₜ(2), . . . , |
| | SFyₜ(q)} |
| Y(t + Δt) = {Sy_{t+Δt}(1), | YF(t + Δt) = {SFy_{t+Δt}(1), |
| Sy_{t+Δt}(2), . . . , Sy_{t+Δt}(q)} | SFy_{t+Δt}(2), . . . , SFy_{t+Δt}(q)} |

Preprocessing may also include interpolation to generate additional data points between existing data points within each series. By adding more data points to each series, the quality of the displacement calculation (using one of the procedures described below) can be improved. In some embodiments, a linear interpolation is used to provide additional data points in each series. For two original consecutive values SF_(i) and SF_(i+1) in one of the XF(t), XF(t+Δt), YF(t) or YF(t+Δt) series (i.e., “_” can be xₜ, x_{t+Δt}, yₜ or y_{t+Δt}), a linear interpolation of grade G will add G−1 values between those two original values. Thus, SF_(1) through SF_(q) becomes SFI_(1) through SFI_((q*G)+1). Each pair SF_(i) and SF_(i+1) of original consecutive data values in a series is replaced with a sub-series of values SF_[(i−1)*G], SFI_[((i−1)*G)+1], . . . , SFI_[((i−1)*G)+h], . . . , SFI_(i*G), where h=1, 2, . . . (G−1). The new values SFI_[((i−1)*G)+h] inserted between the original pair of values are calculated according to Equation 7.
SFI_[((i−1)*G)+h]=(SF_(i)*((G−h)/G))+(SF_(i−1)*(h/G)) Equation 7

After interpolation in accordance with Equation 7, the series XF(t), XF(t+Δt), YF(t) and YF(t+Δt) respectively become XFI(t), XFI(t+Δt), YFI(t) and YFI(t+Δt), as set forth in Table 2.

TABLE 2

| Data Series before | Data Series after |
|---|---|
| Interpolation | Interpolation |
| XF(t) = {SFxₜ(1), SFxₜ(2), | XFI(t) = {SFIxₜ(1), SFIxₜ(2), |
| . . . , SFxₜ(q)} | . . . , SFIxₜ((q*G) + 1)} |
| XF(t + Δt) = {SFx_{t+Δt}(1), | XFI(t + Δt) = {SFIx_{t+Δt}(1), |
| SFx_{t+Δt}(2), . . . , | SFIx_{t+Δt}(2), . . . , |
| SFx_{t+Δt}(q)} | SFIx_{t+Δt}((q*G) + 1)} |
| YF(t) = {SFyₜ(1), SFyₜ(2), | YFI(t) = {SFIyₜ(1), SFIyₜ(2), |
| . . . , SFyₜ(q)} | . . . , SFIyₜ((q*G) + 1)} |
| YF(t + Δt) = {SFy_{t+Δt}(1), | YFI(t + Δt) = {SFIy_{t+Δt}(1), |
| SFy_{t+Δt} (2), . . . , | SFIy_{t+Δt}(2), . . . , |
| SFy_{t+Δt}(q)} | SFIy_{t+Δt}((q*G) + 1)} |

In some embodiments, an interpolation grade G of 10 is used. In various embodiments, a filter rank k equal to the interpolation grade G may also be employed. However, other values of G and/or k can also be used. Although a linear interpolation is described above, the interpolation need not be linear. In other embodiments, a second order, third order, or higher order interpolation may be performed. In some cases, however, interpolations higher than 10th order may provide diminishing returns. Filtering and interpolation can also be performed in a reverse order. For example, series X(t), X(t+Δt), Y(t) and Y(t+Δt) could first be converted to series XI(t), XI(t+Δt), YI(t) and YI(t+Δt). Series XI(t), XI(t+Δt), YI(t) and YI(t+Δt) could then be converted to series XIF(t), XIF(t+Δt), YIF(t) and YIF(t+Δt). Indeed, interpolation and/or filtering are omitted in some embodiments.

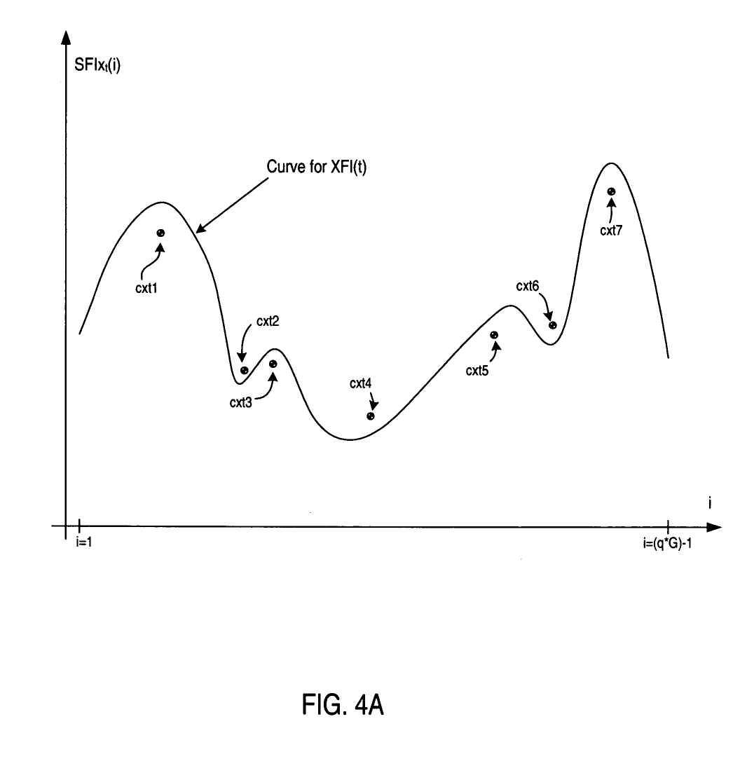

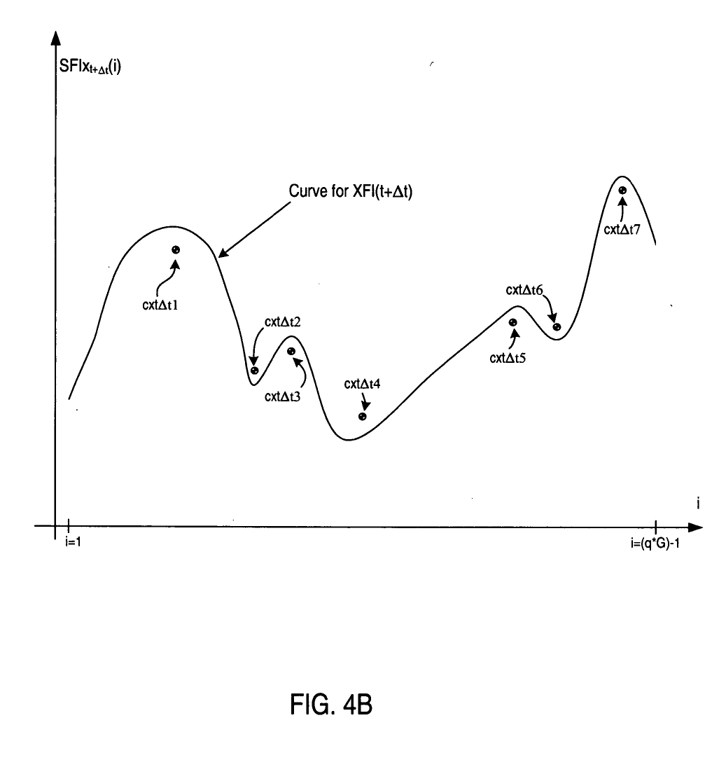

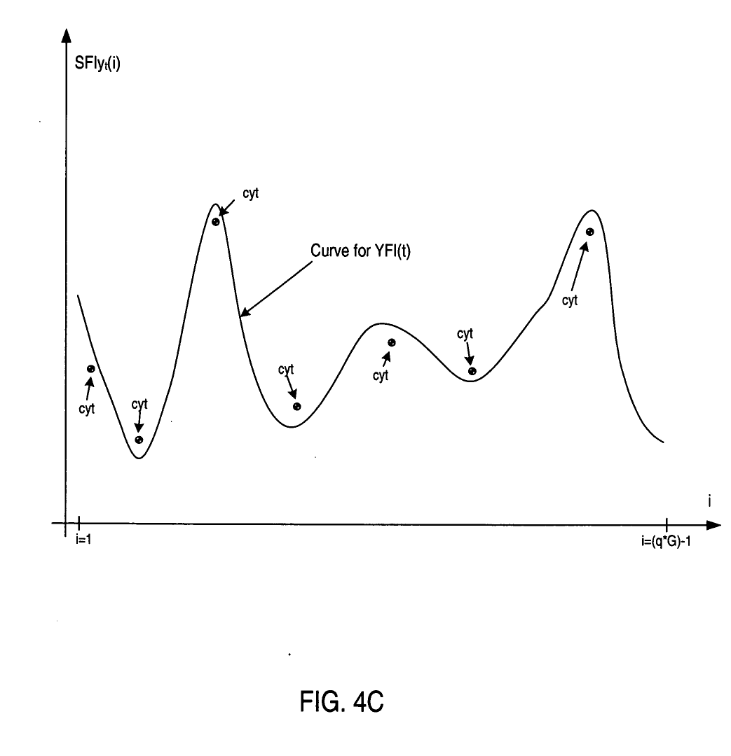

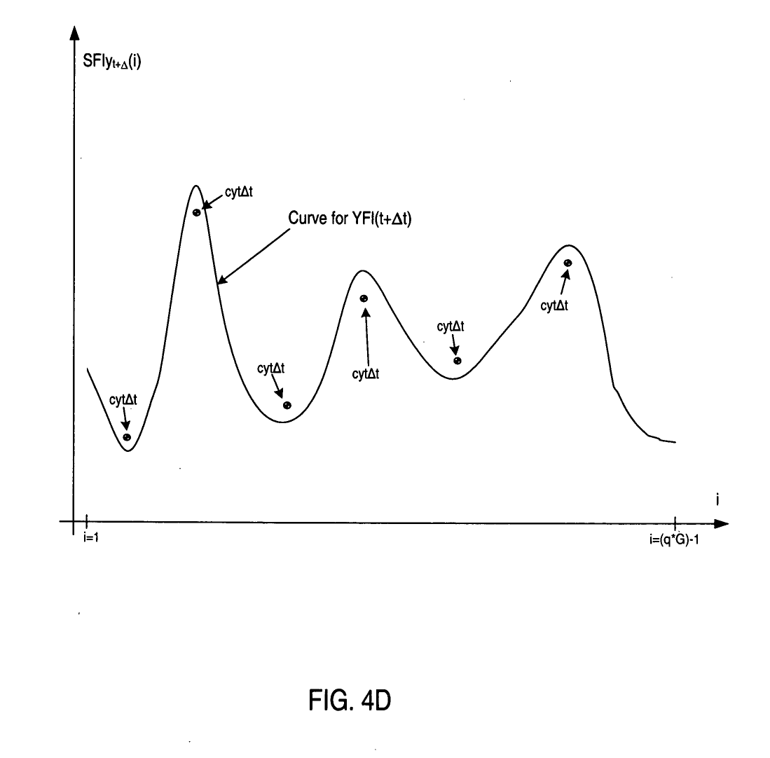

After any preprocessing is performed on each series of condensed pixel output data for the x- and y-dimensions, values for Dx and Dy are determined. In some embodiments, the Dx and Dy displacements are calculated based on centroids for portions of the data within each preprocessed series. For example, FIGS. 4A through 4D are examples of curves that could be drawn for each of four series XFI(t), XFI(t+Δt), YFI(t) and YFI(t+Δt). In practice, actual curves (or other graphical representations) corresponding to each series would not necessarily be generated. However, the graphical representations of the series XFI(t), XFI(t+Δt), YFI(t) and YFI(t+Δt) in FIGS. 4A through 4D help explain the manner in which properties of data within these series is analyzed (by, e.g., computational logic 38 of IC 28) to determine x- and y-dimensional displacement.

Beginning with FIG. 4A, the local maxima and minima in the curve for the series XFI(t) are identified. A centroid (cxt) is then calculated for each local maximum or minimum. Although FIG. 4A shows a total of seven centroids cxt1 through cxt7 corresponding to individual local maxima or minima, the actual number of maxima and minima (and centroids) will vary. In some embodiments, each centroid cxt is simply the i axis value for the local maximum or minimum. In other embodiments, and as shown in FIG. 4A, each centroid is a geometric center of the area under a portion of the XFI(t) curve corresponding to a local maximum or minimum. The area corresponding to each local maximum and minimum could be, e.g., the area between the curve inflection points on either side of the maximum or minimum.

In a similar manner, and as shown in FIGS. 4B-4D, centroids for the local maxima and minima are found for each of the XFI(t+Δt), YFI(t) and YFI(t+Δt) data series.

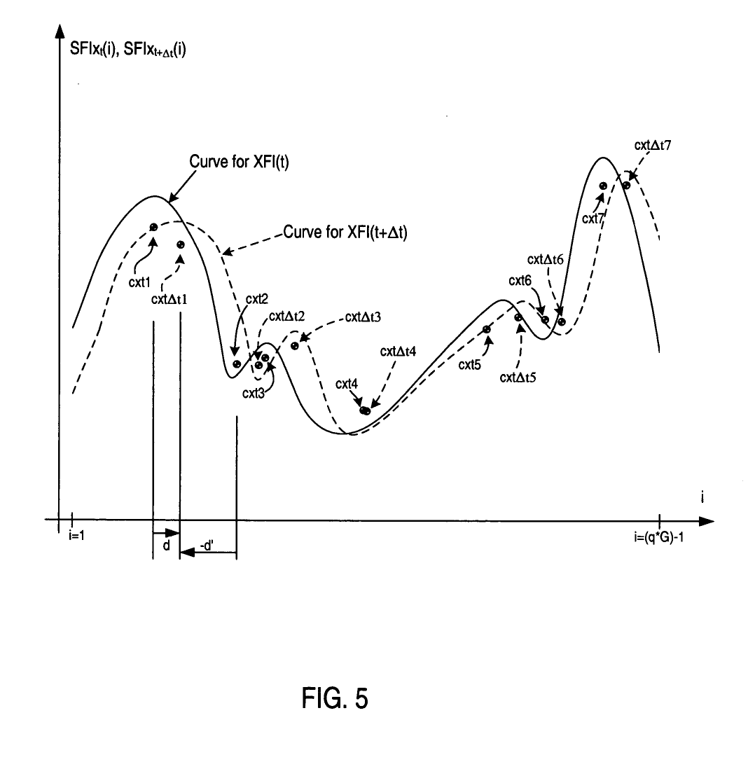

For purposes of comparison in a subsequent drawing figure, centroids in FIG. 4B are labeled cxtΔt1 through cxtΔt7. Centroids in FIGS. 4C and 4D are generically labeled “cyt” or “cytΔt.” The centroids from the XFI(t) series and the XFI(t+Δt) series are compared to determine the x-dimension displacement Dx. As can be seen by overlaying the XFI(t) series curve on the XFI(t+Δt) series curve (FIG. 5), a general shift to the right is apparent. If x-dimension displacement was in the opposite direction, the shift would be to the left. By calculating the amount of this shift and its sign, the magnitude and direction of x-dimension displacement Dx can be determined.

As can also be seen in FIG. 5, the shape of the curve is also changed slightly at time t+Δt. This change in shape is a result of, e.g., noise in the output from pixels in array 26 and the characteristics of speckling in general. This change in shape can complicate the displacement calculation, as it may not be clear which centroid at time t+Δt corresponds to a particular centroid at time t. Matching a centroid at time t+Δt to a centroid at time t may be further complicated if a peak (or trough) near the end of one series is not part of a succeeding series. For example, if the x-dimension motion from time t to time t+Δt was greater, the peak corresponding to centroid cxtΔt7 might move past the i=(q*G)−1 point. A similar problem could occur if the motion was in the opposite direction (e.g., the peak corresponding to centroid cxtΔt1 might move to the right beyond the i=1 point).

For these reasons, a separate i-axis movement vector is calculated from each centroid cxt of the XFI(t) series to each centroid cxtΔt of the XFI(t+Δt) series. In the simplified example of FIG. 5, those vectors would be as listed in Table 3 (where cxtA-cxtΔtB indicates a vector from the position of cxtA to the position of cxtΔtB).

TABLE 3

| | | | | |
|---|---|---|---|---|
| cxt1-cxtΔt1 | cxt2-cxtΔt4 | cxt3-cxtΔt7 | cxt5-cxtΔt3 | cxt6-cxtΔt6 |
| cxt1-cxtΔt2 | cxt2-cxtΔt5 | cxt4-cxtΔt1 | cxt5-cxtΔt4 | cxt6-cxtΔt7 |
| cxt1-cxtΔt3 | cxt2-cxtΔt6 | cxt4-cxtΔt2 | cxt5-cxtΔt5 | cxt7-cxtΔt1 |
| cxt1-cxtΔt4 | cxt2-cxtΔt7 | cxt4-cxtΔt3 | cxt5-cxtΔt6 | cxt7-cxtΔt2 |
| cxt1-cxtΔt5 | cxt3-cxtΔt1 | cxt4-cxtΔt4 | cxt5-cxtΔt7 | cxt7-cxtΔt3 |
| cxt1-cxtΔt6 | cxt3-cxtΔt2 | cxt4-cxtΔt5 | cxt6-cxtΔt1 | cxt7-cxtΔt4 |
| cxt1-cxtΔt7 | cxt3-cxtΔt3 | cxt4-cxtΔt6 | cxt6-cxtΔt2 | cxt7-cxtΔt5 |
| cxt2-cxtΔt1 | cxt3-cxtΔt4 | cxt4-cxtΔt7 | cxt6-cxtΔt3 | cxt7-cxtΔt6 |
| cxt2-cxtΔt2 | cxt3-cxtΔt5 | cxt5-cxtΔt1 | cxt6-cxtΔt4 | cxt7-cxtΔt7 |
| cxt2-cxtΔt3 | cxt3-cxtΔt6 | cxt5-cxtΔt2 | cxt6-cxtΔt5 | |

Each movement vector has a sign indicating a direction of motion and a magnitude reflecting a distance moved. Thus, for example, the cxt1-cxtΔt1 vector is d, with the positive sign indicating movement to the right on the i-axis. A cxt2-cxtΔt1 vector is −d′, with the negative sign indicating movement in the opposite direction on the i-axis. The distribution of all of these cxt-cxtΔt vectors is then analyzed. Many of the cxt-cxtΔt vectors will be for matching centroid pairs, i.e., centroids for a peak or valley of the XIF(t) series and a corresponding peak or valley of the XIF(t+Δt) series. These vectors will generally have moved in an amount and direction which is the same (or close to the same) as the displacement Dx of array 26. For example, vectors cxt1-cxtΔt1, cxt2-cxtΔt2, cxt3-cxtΔt3, cxt4-cxtΔt4, cxt5-cxtΔt5, cxt6-cxtΔt6 and cxt7-cxtΔt7 have approximately the same magnitude and direction as the displacement Dx. The other cxt-cxtΔt vectors (e.g., cxt1-cxtΔt2, cxt2-cxtΔt1, etc.) will generally be in both directions and will have a range of magnitudes. However, the largest concentration of vectors in the distribution of cxt-cxtΔt vectors will correspond to Dx.

If each part of the curve for a series at time t is shifted by an equal amount in the curve at time t+Δt, determining displacement Dx would be a simple matter of determining which single cxt-cxtΔt distance value occurs most often. As indicated above, however, the shape of the curve may change somewhat between times t and t+Δt. Because of this, the distances between the centroids of each matching cxt-cxtΔt pair may not be precisely the same. For example, the i-axis distance between cxt1 and cxtΔt1 may be slightly different than the distance between cxt6 and cxtΔt6. Accordingly, a probability analysis is performed on the distribution of cxt-cxtΔt vectors. In some embodiments, this analysis includes categorizing all of the cxt-cxtΔt vectors into subsets based on ranges of distances moved in both directions. For example, one subset may be for cxt-cxtΔt vectors of between 0 and +10 (i.e., movement of between 0 and 10 increments to the right along the i-axis), another subset may be for vectors between 0 and −10 (0 to 10 increments to the left), yet another subset may be for vectors between +11 and +20, etc. The subset containing the most values is identified, the cxt-cxtΔt vectors in that subset are averaged, and the average value is output as x-dimension displacement Dx.

The centroids from the YFI(t) series and the YFI(t+Δt) series are compared in a similar manner to determine the y-dimension displacement Dy. In particular, the movement vectors on the i-axis between each centroid cyt of the YFI(t) series and each centroid cytΔt of the YFI(t+Δt) series are calculated. A similar probability analysis is then performed on the distribution of these cyt-cytΔt vectors, and the y-dimension displacement Dy is output.

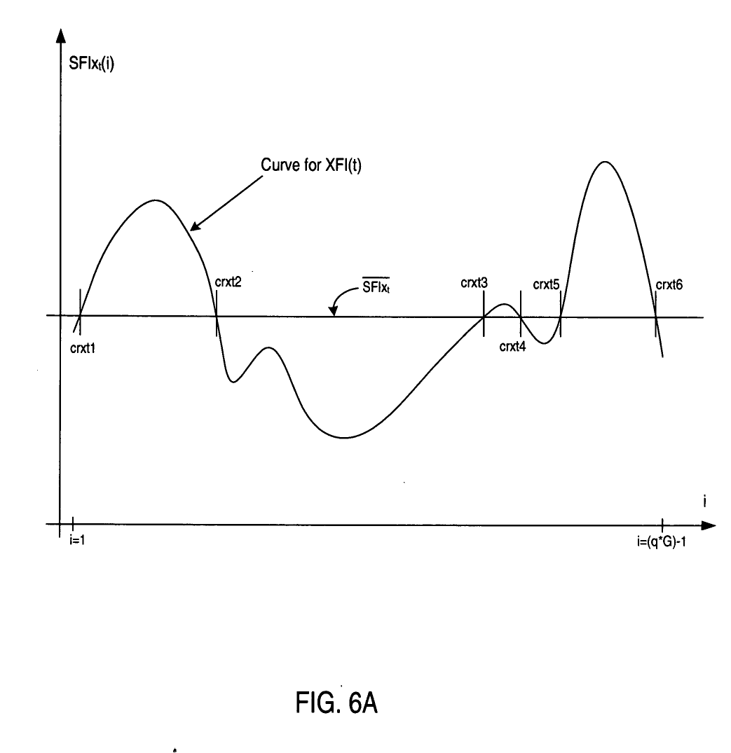

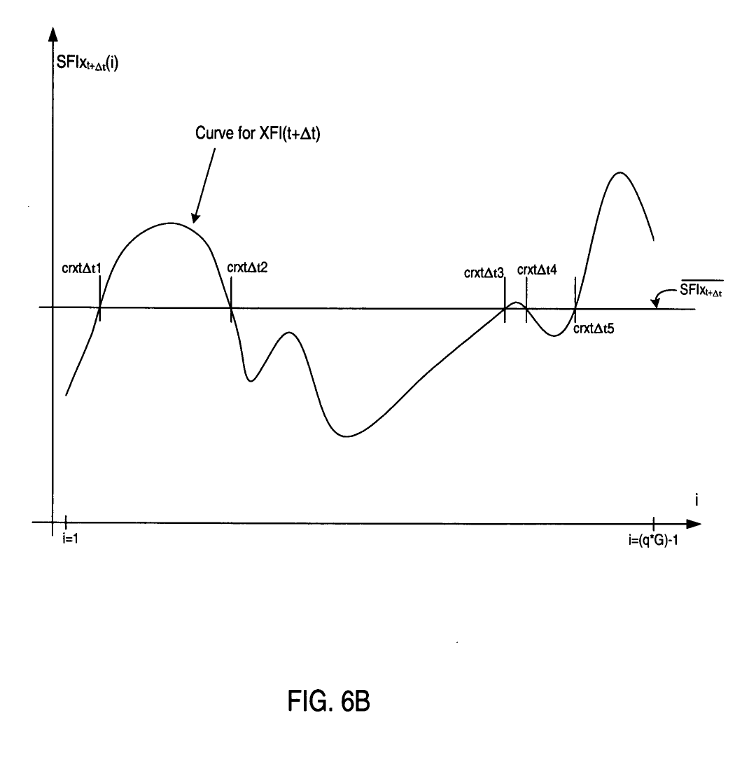

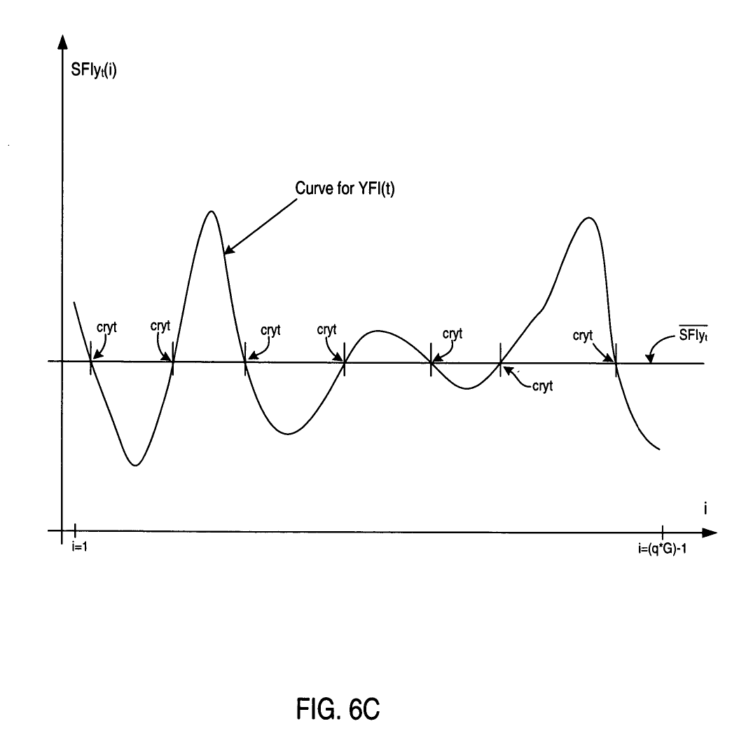

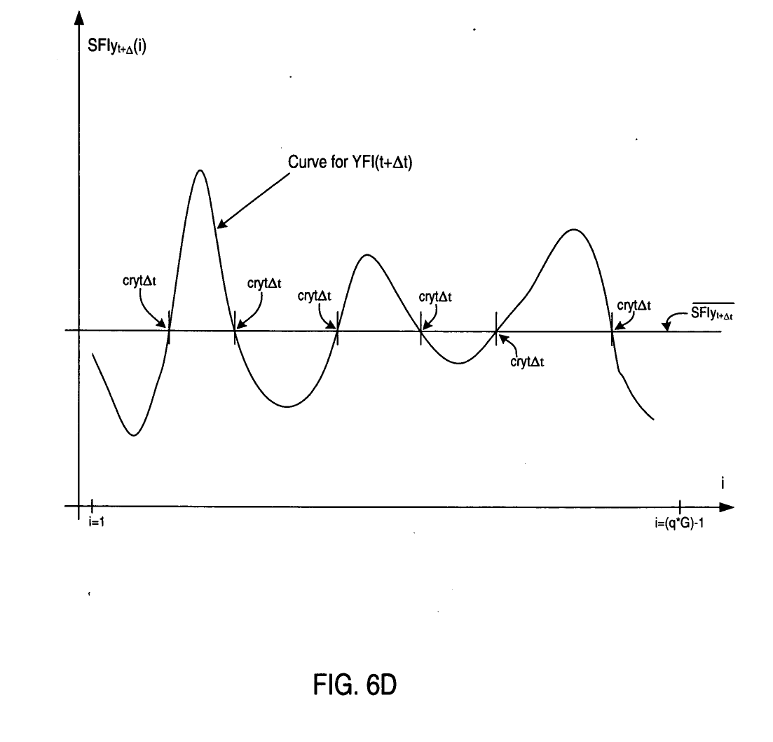

In other embodiments, a level-crossing technique is used to determine displacement. Instead of determining local maxima and minima for each XFI(t), XFI(t+Δt), YFI(t) and YFI(t+Δt) data series and then finding centroids for those maxima and minima, a reference value is calculated for each series. This reference value may be, e.g., an average of the values within a series. As shown in FIG. 6A, an average value S̅F̅I̅x̅ₜ̅=((SFIxₜ(1)+ . . . +SFIxₜ((q*G)−1))/((q*G)−1)) is calculated for the XFI(t) series. As indicated in FIGS. 6B through 6D, average values S̅F̅I̅x̅_̅{̅t̅+̅Δ̅t̅}̅, S̅F̅I̅y̅ₜ̅, and S̅F̅I̅y̅_̅{̅t̅+̅Δ̅t̅}̅ are calculated in a similar manner using the data values within each of the respective XFI(t+Δt), YFI(t) and YFI(t+Δt) data series. Next, the points at which a curve corresponding to the XFI(t) series crosses the S̅F̅I̅x̅ₜ̅ value are determined. These crossing points are shown in FIG. 6A as crxt1 through crxt6. Similar operations are performed for the XFI(t+Δt), YFI(t) and YFI(t+Δt) series, as shown in FIGS. 6B through 6D. Crossing points crxtΔt1 through crxtΔt5 are specifically labeled in FIG. 6B for purposes of comparison in a subsequent drawing figure. Crossing points in FIGS. 6C and 6D are generically labeled “cryt” or “crytΔt.”

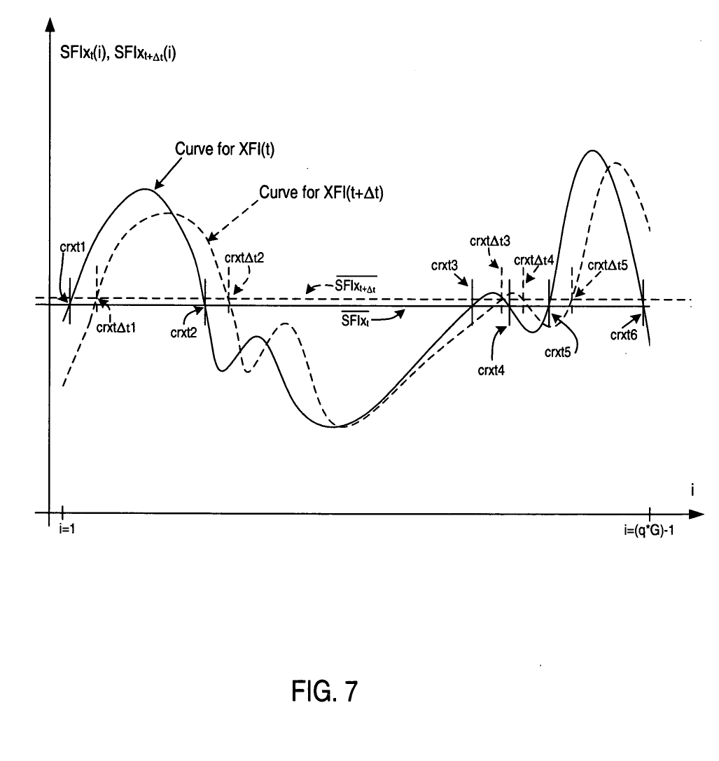

FIG. 7 shows the graph of FIG. 6A superimposed on the graph of FIG. 6B. As seen in FIG. 7, distances between crossing points crxt and crossing points crxΔt can be used, in a manner analogous to that discussed above for the series data centroids, to determine x-dimension displacement Dx. In a manner similar to the above-described centroid-based displacement determination technique, an i-axis vector from each crossing point crxt of the XFI(t) series to each crossing point crxtΔt of the XFI(t+Δt) series is first calculated. A probability analysis is then performed on the distribution of crxt-crxtΔt vectors. The probability analysis employed can be, e.g., the same type of probability analyses previously described (e.g., placing all of the crxt-crxtΔt vectors into subsets and averaging the vectors in the subset having the most members). Based on the probability analysis of the crxt-crxtΔt vector distribution, a Dx value is output.

A Dy value is obtained from the YFI(t) series and the YFI(t+Δt) series in a similar manner. In particular, the movement vectors on the i-axis between each crossing point cryt of the YFI(t) series and each crossing point crytΔt of the YFI(t+Δt) series are calculated. A similar probability analysis is then performed on the distribution of these cryt-crytΔt vectors, and the y-dimension displacement Dy is output.

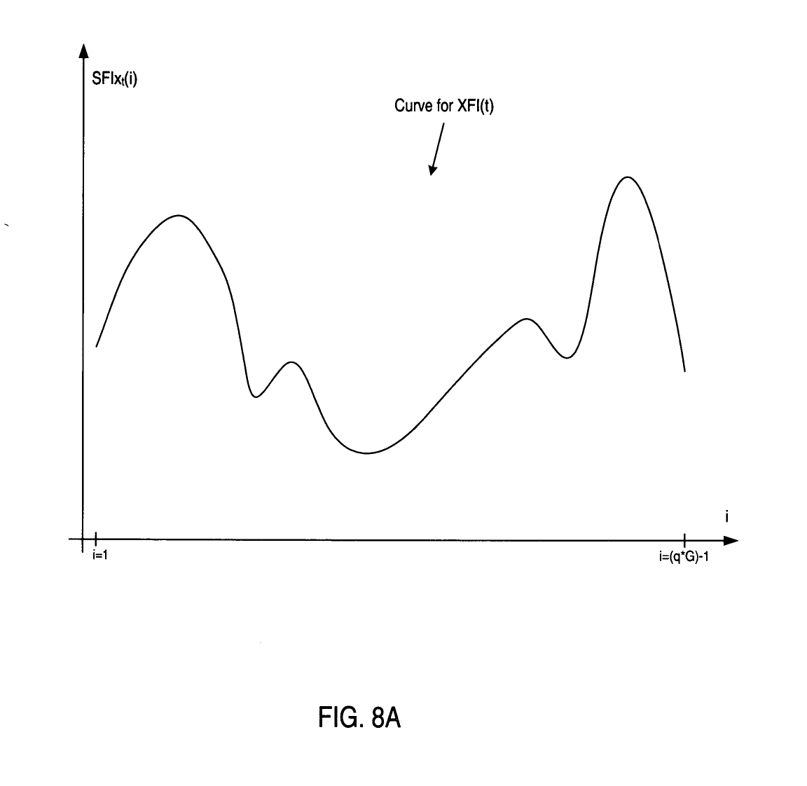

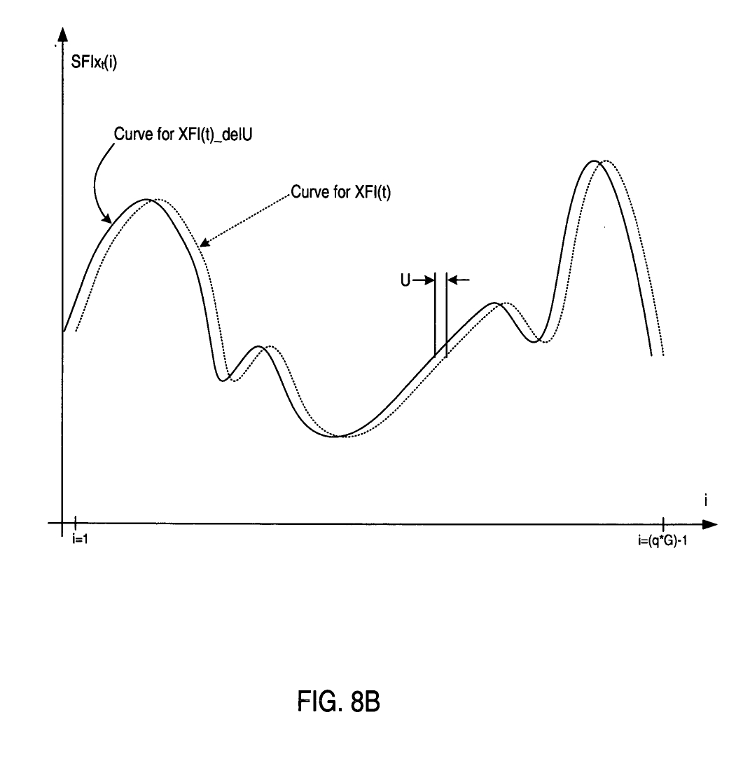

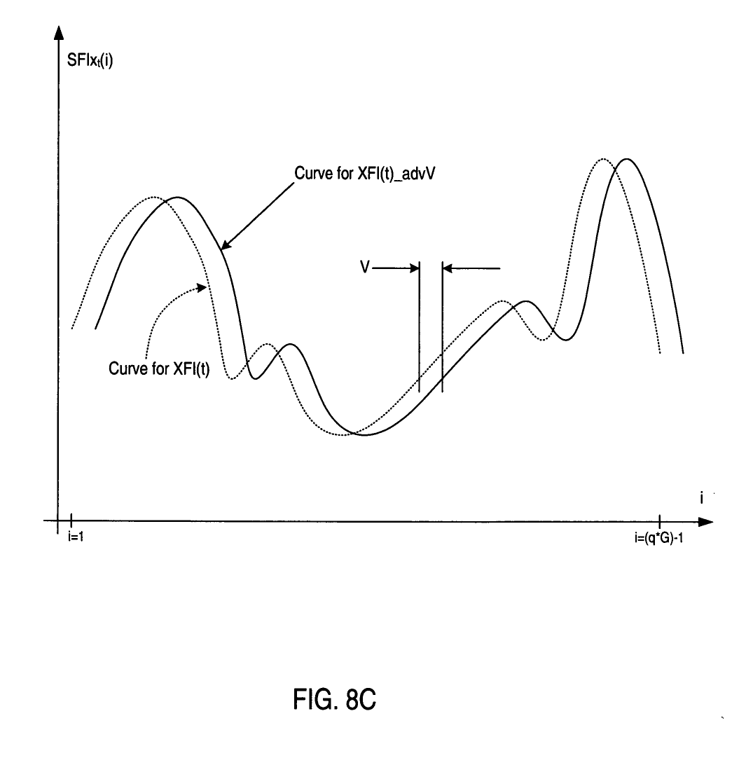

In still other embodiments, a correlation technique is used for displacement determination. In this technique, x-dimension displacement is determined by correlating the XFI(t+Δt) data series with multiple versions of the XFI(t) data series that have been advanced or delayed. For example, FIG. 8A shows a curve corresponding to the XFI(t) data series, similar to FIGS. 4A and 6A. FIG. 8B shows (as series XFI(t)_delU) the series of FIG. 8A delayed by an arbitrary number of increments U along the i-axis. In other words, SFIxₜ(i) of series XFI(t)_delU is equal to SFIxₜ(i+U) of series XFI(t). FIG. 8C shows (as series XFI(t)_advV) the series of FIG. 8A advanced by an arbitrary number of increments V along the i-axis. In other words, SFIxₜ(i) of series XFI(t)_advV is equal to SFIxₜ(i-V) of series XFI(t).

The XFI(t+Δt) data series is correlated with each of the delayed and advanced versions of the XFI(t) data series. In other words XFI(t+Δt) is correlated with each of XFI(t)_delU₁, . . . , XFI(t)_delUₘₐₓ and with each of XFI(t)_advV₁. XFI(t)_advVₘₐₓ. In at least some embodiments, this correlation is performed using Equation 8.

$$C = \frac{{\sum }_{i = 1}^{m} [ \begin{matrix}[ {SIFx}_{t + Δ t} ( i ) - \overline{{SIFx}_{t + Δ t}} ] * \\ [ {SIFx}_{t}^{′} ( i ) - \overline{{SIFx}_{t}^{′}} ]\end{matrix} ]}{\sqrt{{\sum }_{i = 1}^{m} {[ {SIFx}_{t + Δ t} ( i ) - \overline{{SIFx}_{t + Δ t}} ]}^{2}} \sqrt{{\sum }_{i = 1}^{m} {[ {SIFx}_{t}^{′} ( i ) - \overline{{SIFx}_{t}^{′}} ]}^{2}}} , where \qquad Equation 8$$

C=a correlation coefficient for a comparison of the XFI(t+Δt) data series with an advanced or delayed version of the XFI(t) data series
m=the number of data values in each series ((q*G)+1) in the present example)
SIFx_{t+Δt}(i)=the i^{th} data value in the XFI(t+Δt) data series

$$\overline{{SIFx}_{t + Δ t}} = \frac{{SFIx}_{t + Δ t} ( 1 ) + {SFIx}_{t + Δ t} ( 2 ) + … + {SFIx}_{t + Δ t} ( m )}{m}$$
SIFxₜ′(i)=the i^{th} data value in the advanced or delayed series (XFI(t)_delU or XFI(t)_advV) being compared to the XFI(t+Δt) data series

$$\overline{{SIFx}_{t}^{′}} = \frac{{SFIx}_{t}^{′} ( 1 ) + {SFIx}_{t}^{′} ( 2 ) + … + {SFIx}_{t}^{′} ( m )}{m}$$

A correlation coefficient C is calculated for each comparison of the XFI(t+Δt) data series to an advanced or delayed version of the XFI(t) data series. In some embodiments, correlation coefficients are calculated for comparisons with versions of the XFI(t) data series having delays of 1, 2, 3, . . . , 30 (i.e., U₁=1 and Uₘₐₓ=30), and for comparisons with versions of the XFI(t) data series having advancements of 1, 2, 3, . . . , 30 (i.e., V₁=1 and Vₘₐₓ=30). Other values for Vₘₐₓ and Uₘₐₓ could be used, however, and Vₘₐₓ need not equal Uₘₐₓ. The value of delay U or advancement V corresponding to the maximum value of the correlation coefficient C is then output as the displacement Dx. If, for example, the highest correlation coefficient C corresponded to a version of the XFI(t) data series having a delay U of 15, the displacement would be −15 i-axis increments. If the highest correlation coefficient C corresponded to a version of the XFI(t) data series having an advancement V of +15, the displacement would be +15 i-axis increments.

Y-dimension displacements Dy are determined in a similar manner. In other words, the YFI(t+Δt) data series is compared, according to Equation 9, with multiple versions of the YFI(t) data series that have been advanced or delayed (YFI(t)_delU₁, . . . , YFI(t)_delUₘₐₓ and YFI(t)_advV₁, . . . , YFI(t)_advVₘₐₓ).

$$C = \frac{{\sum }_{i = 1}^{m} [ \begin{matrix}[ {SIFy}_{t + Δ t} ( i ) - \overline{{SIFy}_{t + Δ t}} ] * \\ [ {SIFy}_{t}^{′} ( i ) - \overline{{SIFy}_{t}^{′}} ]\end{matrix} ]}{\sqrt{{\sum }_{i = 1}^{m} {[ {SIFy}_{t + Δ t} ( i ) - \overline{{SIFy}_{t + Δ t}} ]}^{2}} \sqrt{{\sum }_{i = 1}^{m} {[ {SIFy}_{t}^{′} ( i ) - \overline{{SIFy}_{t}^{′}} ]}^{2}}} , where \qquad Equation 9$$

C=a correlation coefficient for a comparison of the YFI(t+Δt) data series with an advanced or delayed version of the YFI(t) data series
m=the number of data values in each series ((q*G)+i) in the present example)
SIFy_{t+Δt}(i)=the i^{th} data value in the YFI(t+Δt) data series

$$\overline{{SIFy}_{t + Δ t}} = \frac{{SFIy}_{t + Δ t} ( 1 ) + {SFIy}_{t + Δ t} ( 2 ) + … + {SFIy}_{t + Δ t} ( m )}{m}$$
SIFyₜ′(i)=the i^{th} data value in the advanced or delayed series being compared to the YFI(t+Δt) data series

$$\overline{{SIFy}_{t}^{′}} = \frac{{SFIy}_{t}^{′} ( 1 ) + {SFIy}_{t}^{′} ( 2 ) + … + {SFIy}_{t}^{′} ( m )}{m}$$

The value of delay U or advancement V corresponding to the maximum value of the correlation coefficient C is output as the displacement Dy. As with determination of Dx, other values for Vₘₐₓ, and Uₘₐₓ could be used, and Vₘₐₓ need not equal Uₘₐₓ.

The astute observer will note that, at the “edges” of the XFI(t) curve in FIGS. 8A-8C, determining an advanced or delayed value may be difficult. In FIG. 8B, for example, the value for SFIxₜ((q*G)−1) of series XFI(t)_delU would be value SFIxₜ((q*G)−1+U) of the series XFI(t). There is no such value in the XFI(t) series (see Table 2, above). A similar circumstance arises with regard to the value for SFIxₜ(1) of series XFI(t)_advV in FIG. 8C. In practice, however, this is generally not a significant issue. If there are sufficient values between the edges of two series being correlated, any irregularities at the edges of a series will not produce significant errors in a final correlation value. Thus, some of the edge values for an XFI(t) or YFI(t) series could be repeated for several of the edge values in an advanced or delayed version of that series. As another alternative, Equations 8 and 9 could be modified so that a narrower correlation window is used. In other words, the summations in Equations 8 and 9 would be from i=a to i=b, where, e.g., a>(1+Vₘₐₓ) and b<((q*G)−1−Uₘₐₓ).

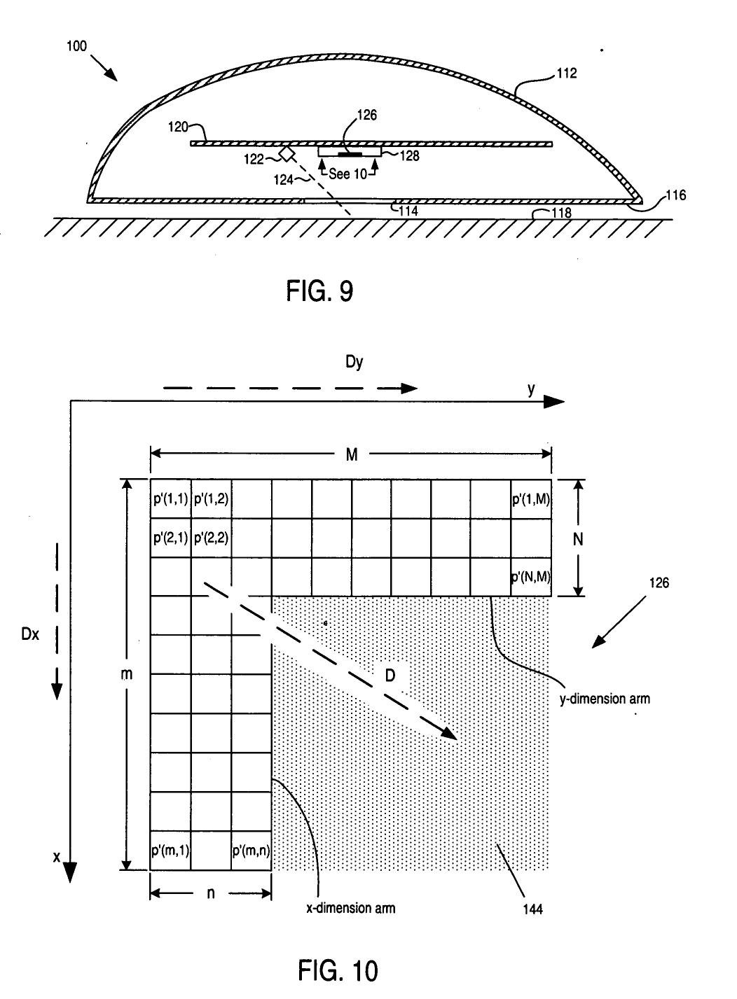

The embodiments described above employ a conventional rectangular array. In other embodiments, an array of reduced size is used. FIG. 9 shows a computer mouse 100 according to at least one such embodiment. As with mouse 10 of FIG. 1, mouse 100 includes a housing 112 having an opening 114 formed in a bottom face 116. Located within mouse 100 on PCB 120 is a laser 122 and motion sensing IC 128. Laser 122, which is similar to laser 22 of FIG. 1, directs a beam 124 onto surface 118. IC 128 is also similar to IC 28 of FIGS. 1 and 2, but includes a modified array 126 and determines motion using a modification of one of the previously described techniques.

FIG. 10 is a partially schematic diagram of array 126 taken from the position indicated in FIG. 9. Similar to FIG. 3, pixels in array 126 are labeled p′(r,c), where r and c are the respective row and column on the x and y dimensions shown. Unlike the embodiment of FIG. 3, however, array 126 is an “L”-shaped array. Specifically, array 126 includes an x-dimension arm having dimensions m by n, and a y-dimension arm having dimensions M by N. A pixel-free region 144 is located between the x- and y-axis arms. Accordingly, other components of IC 128 (e.g., computational elements, signal processing elements, memory) can be located in region 144. In at least some embodiments, pixel-free region 144 is at least as large as a square having sides equal to the average pixel pitch in the x- and y-dimension arms. As in FIG. 3, the unnumbered squares in FIG. 10 correspond to an arbitrary number of pixels. In other words, and notwithstanding the fact that FIG. 10 literally shows M=m=10 and N=n=3, these values are not necessarily the same in all embodiments. Moreover, M need not necessarily equal m, and N need not necessarily equal n.

In order to calculate the x-dimension displacement Dx in the embodiment of FIGS. 9 and 10, data based on the pixel outputs from each x row are condensed, for times t and t+Δt, according to Equations 10 and 11.
Sxₜ(r)=Σ_{c=1}ⁿ pixₜ(r,c), for r=1, 2, . . . m Equation 10
Sx_{t+Δt}(r)=Σ_{c=1}ⁿpix_{t+Δt}(r,c), for r=1, 2, . . . m Equation 11

In Equation 10 and 11, “pixₜ(r, c)” and “pix_{t+Δt}(r, i)” are data corresponding to the outputs (at times t and t+Δt, respectively) of the pixel in row r, column c of array 126. In order to calculate the y-dimension displacement Dy in the embodiment of FIGS. 9 and 10, data based on the pixel outputs from each y column are also condensed, for times t and t+Δt, according to Equations 12 and 13.
Syₜ(c)=Σᵣ₌₁^{N}pixₜ(r,c), for c=1, 2, . . . M Equation 12
Sy_{t+Δt}(c)=Σᵣ₌₁^{N}pix_{1+Δt}(r,c), for c=1, 2, . . . M Equation 13

As in Equations 10 and 11, “pixₜ(r,c)” and “pix_{t+Δt}(r,c)” in Equations 12 and 13 are data corresponding to the outputs (at times t and time t+Δt, respectively) of the pixel in row r, column c. Data series generated with Equations 10 through 13 can be used, in the same manner as data series generated with Equations 1 through 4, in one of the previously described techniques to determine x- and y-dimension displacements.

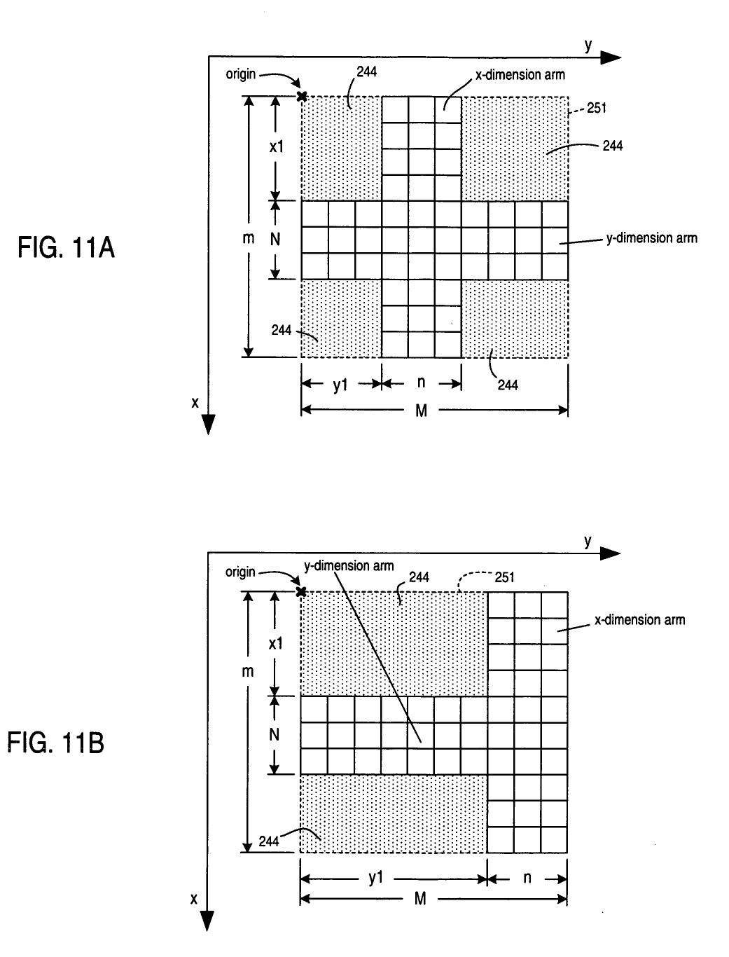

As can be appreciated from FIG. 10, the embodiment of FIGS. 9 and 10 allows additional freedom when designing a motion sensing IC such as IC 128. For example, and as shown in FIGS. 11A and 11B, the x- and y-dimension arms of an array can be reoriented in many different ways. In FIGS. 11A and 11B, the x- and y-dimension arms still have dimensions m by n and M by N, respectively. However, the relative positioning of these arms is varied. In the examples of FIGS. 11A and 11B, the x- and y-dimension arms are contained within a footprint 251, which footprint further includes one or more pixel-free regions 244. In each case, the x-dimension arm is offset from an origin of footprint 251 by a number of pixels y1. Similarly, the y-dimension arms in FIGS. 11A and 11B are offset from the origins by a number of pixels x1. The quantities M, N, m, n, x1 and y1 represent arbitrary values, For example, x1 in FIG. 11A does not necessarily have the same value as x1 in FIG. 11B (or as x1 in some other pixel arrangement). Indeed, x1 and/or y1 could have a value of zero, as in the case of FIG. 10.

Equations 10 through 13 can be generalized as Equations 14 through 17.
Sxₜ(r)=Σ_{c=y1+1}^{y1+n}pixₜ(r, c), for r=1, 2, . . . m Equation 14
Sx_{t+Δt}(r)=Σ_{c=y1+1}^{y1+n}pix_{t+Δt}(r,c), for r=1, 2, . . . m Equation 15
Syₜ(c)=Σᵣ₌ₓ₁₊₁^{x1+N}pixₜ(r,c), for c=1, 2, . . . M Equation 16
Sy_{t+Δt}(c)=Σᵣ₌ₓ₁₊₁^{x1+N}pix_{t+Δt}(r,c), for c=1, 2, . . . M Equation 17

In Equations 14 through 17, x1 and y1 are x- and y-dimension offsets (such as is shown in FIGS. 11A and 11B). The quantities pixₜ(r,c) and pix_{t+Δt}(r,c) are data corresponding to pixel outputs at times t and t+Δt from the pixel at row r, column c. If x1 and y1 are both zero, Equations 14 through 17 reduce to Equations 10 through 13. If x1 and y1 are both zero, and if M=N=m=n, Equations 14 through 17 reduce to Equations 1 through 4.

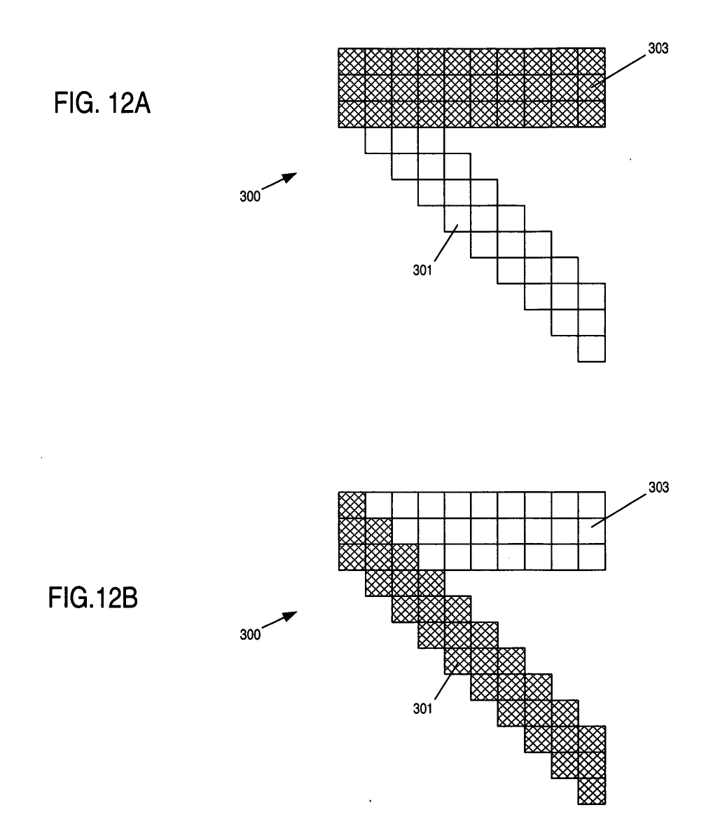

In still other embodiments, the arms of the array are not orthogonal. As shown in FIGS. 12A and 12B, an array 300 has pixels arranged in two arms 301 and 303. Motion relative to array 300 is determined by calculating components along arms 301 and 303. The component parallel to arm 303 is determined using the pixels cross-hatched in FIG. 12A. The component parallel to arm 301 is determined using the pixels cross-hatched in FIG. 12B. Derivation of equations similar to those employed for the embodiments of FIGS. 1 through 11B are within the routine ability of persons skilled in the art, once such persons are provided with the description provided herein.

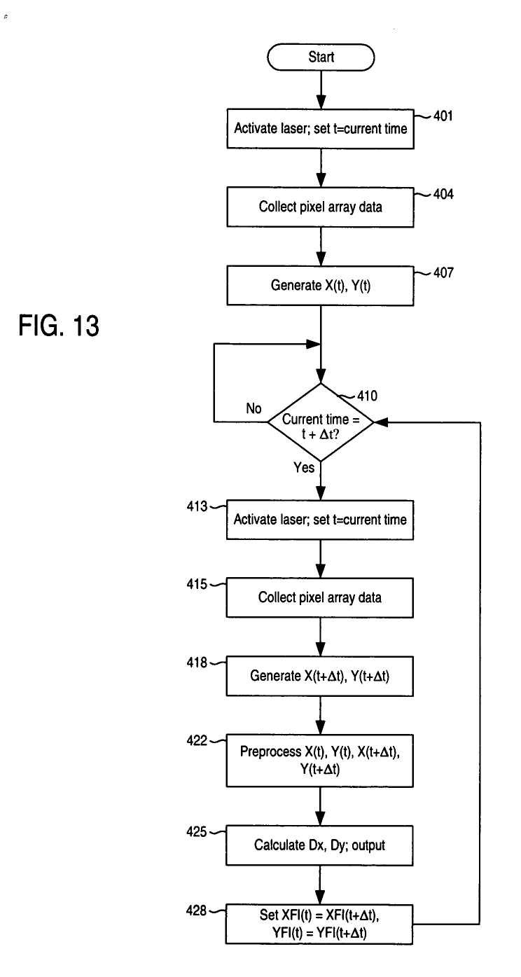

FIGS. 13 through 15C are flow charts showing algorithms for determining motion along two dimensions such as have been previously discussed. For simplicity, FIGS. 13 through 15C are primarily described by reference to mouse 10 of FIGS. 1 through 3. However, the algorithms of FIGS. 13 through 15C could also be performed by computational logic within IC 128 of mouse 100, or by computational logic of a processor contained in some other type of motion tracking device.

Beginning with FIG. 13, the algorithm commences and proceeds to block 401. In block 401, computational logic 38 of IC 28 activates laser 22 and sets a variable t equal to the current system time. The algorithm proceeds to block 404, where pixel array outputs are collected and data corresponding to those outputs is stored in RAM 36. In block 407, logic 38 then accesses the data in RAM 36 and creates series X(t) and Y(t) using Equations 1 and 3. The algorithm then proceeds to block 410, where logic 38 determines if the elapsed time equals the imaging frame period Δt. If not, the algorithm loops back to block 410 along the “no” branch. If so, the algorithm proceeds on the “yes” branch to block 413. In block 413, logic 38 activates laser 22 again, and resets the t variable to the current time. The algorithm then proceeds to block 415, where pixel array outputs are again collected and data corresponding to those outputs is stored in RAM 36. The algorithm the proceeds to block 418, where logic 38 accesses the data in RAM 36 and creates series X(t+Δt) and Y(t+Δt) using Equations 2 and 4.

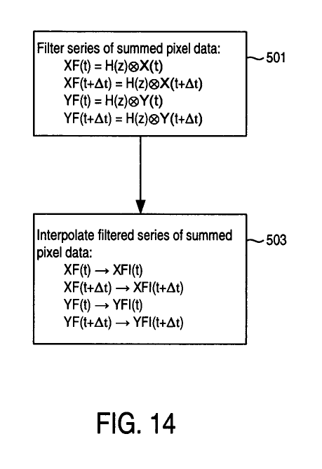

The algorithm then proceeds to block 422, where logic 38 performs preprocessing on the data series X(t), Y(t), X(t+Δt) and Y(t+Δt). FIG. 14 shows the preprocessing of block 422 in more detail. In block 501, logic 38 filters each series X(t), Y(t), X(t+Δt) and Y(t+Δt) using Equations 5 and 6 to obtain filtered series XF(t), YF(t), XF(t+Δt) and YF(t+Δt). The algorithm then proceeds block 503, where logic 38 interpolates each series XF(t), YF(t), XF(t+Δt) and YF(t+Δt) using Equation 7 to obtain interpolated and filtered series XFI(t), YFI(t), XFI(t+Δt) and YFI(t+Δt). From block 503, the algorithm proceeds to block 425 (FIG. 13).

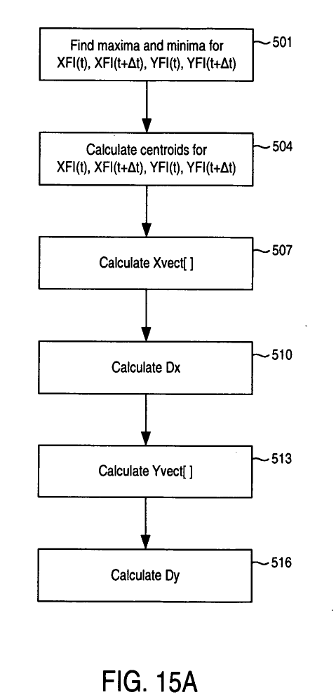

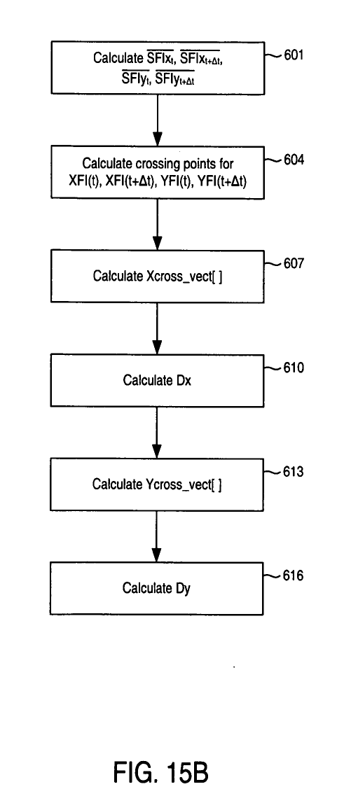

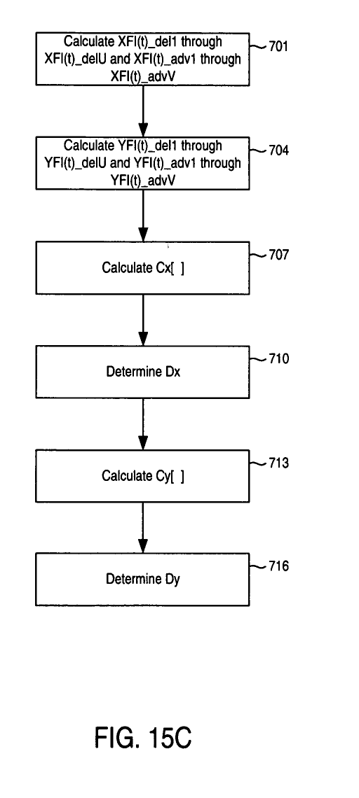

In block 425, logic 38 calculates Dx and Dy displacements using the data of interpolated and filtered series XFI(t), YFI(t), XFI(t+Δt) and YFI(t+Δt). As previously described, this determination can be performed in several ways. In embodiments employing the centroid technique described in connection with FIGS. 4A through 5, block 425 includes the steps shown in FIG. 15A. In block 501, logic 38 finds local maxima and minima for each of the series XFI(t), YFI(t), XFI(t+Δt) and YFI(t+Δt). The algorithm then proceeds to block 504, where logic 38 calculates centroids for each of those local maxima and minima. The algorithm then proceeds to block 507. In block 507, logic 38 calculates vectors from all of the centroids in the XFI(t) series to all of the centroids in the XFI(t+Δt) series. For simplicity, block 507 shows all of these vectors being stored in an array Xvect[ ], although other manners of storing the vectors could be employed. After calculating all of the x-dimension vectors, logic circuitry calculates x-dimension displacement Dx in block 510 by performing a probability analysis on the x-dimension vectors. Logic 38 then proceeds to block 513 and calculates vectors from all of the centroids in the YFI(t) series to all of the centroids in the YFI(t+Δt) series (shown as an array Yvect[ ]). Logic 38 then performs a probability analysis on the y-dimension vectors in block 516 and calculates y-dimension displacement Dy. The Dx and Dy values are then output, as shown in block 425 (FIG. 13).

In embodiments employing the level crossing technique described in connection with FIGS. 6A through 7, block 425 includes the steps shown in FIG. 15B. In block 601, logic 38 calculates values for S̅F̅I̅x̅ₜ̅, S̅F̅I̅x̅_̅{̅t̅+̅Δ̅t̅}̅, S̅F̅I̅y̅ₜ̅ and S̅F̅I̅y̅_̅{̅t̅+̅Δ̅t̅}̅ as previously described. In block 604, logic 38 then determines the points at which data in each of the XFI(t), YFI(t), XFI(t+Δt) and YFI(t+Δt) series respectively crosses S̅F̅I̅x̅ₜ̅, S̅F̅I̅x̅_̅{̅t̅+̅Δ̅t̅}̅, S̅F̅I̅y̅ₜ̅ and S̅F̅I̅y̅_̅{̅t̅+̅Δ̅t̅}̅. The algorithm then proceeds to block 607, where logic 38 calculates vectors from all of the crossing points in the XFI(t) series to all of the crossing points in the XFI(t+Δt) series (shown for simplicity in block 607 as an array Xcross_vect[ ], although other manners of storing the vectors could be employed). After calculating all of the x-dimension level crossing vectors, logic 38 calculates x-dimension displacement Dx in block 610 by performing a probability analysis on those x-dimension vectors. Logic 38 then proceeds to block 613 and calculates vectors from all of the crossing points in the YFI(t) series to all of the crossing points in the YFI(t+Δt) series (shown as an array Ycross_vect[ ]). Logic 38 then performs a probability analysis on those y-dimension vectors in block 616 and calculates y-dimension displacement Dy. The Dx and Dy values are then output, as shown in block 425 (FIG. 13).

In embodiments employing the correlation technique previously described in connection with FIGS. 8A through 8C, block 425 includes the steps shown in FIG. 15C. In block 701, logic 38 calculates series XFI(t)_dell through XFI(t)_delU for delays of the XFI(t) series between 1 and U, as well as series XFI(t)_adv1 through XFI(t)_advV for advancements of the XFI(t) series between 1 and V. In block 704, logic 38 calculates series YFI(t)_dell through YFI(t)_delU for delays of the YFI(t) series between 1 and U, as well as series YFI(t)_adv1 through YFI(t)_advV for advancements of the YFI(t) series between 1 and V. The values for U and V used in block 704 need not be the same U and V values used in block 701. The algorithm then proceeds to block 707, where logic 38 calculates correlation coefficients C for comparisons (according to Equation 8) of the XFI(t+Δt) series with each of the XFI(t)_del1 through XFI(t)_delU series and each of the XFI(t)_adv1 through XFI(t)_advV series. For simplicity, this is shown as an array Cx[ ], although other manners of storing the correlation coefficients could be employed. After calculating all of the x-dimension correlation coefficients, logic 38 calculates x-dimension displacement Dx in block 710 by identifying the highest correlation coefficient. Logic 38 then proceeds to block 713 and calculates correlation coefficients C for comparisons (according to Equation 9) of the YFI(t+Δt) series with each of the YFI(t)_dell through YFI(t)_delU series and each of the YFI(t)_adv1 through YFI(t)_advV series (shown as an array Cy[ ]). Logic 38 calculates y-dimension displacement Dy in block 716 by identifying the highest y-dimension correlation coefficient. The Dx and Dy values are then output, as shown in block 425 (FIG. 13).

From block 425, the algorithm proceeds to block 428, In block 428, logic 38 sets the series XFI(t) equal to the series XFI(t+Δt) and sets the series YFI(t) equal to the series YFI(t+Δt). The algorithm then returns to block 410. After another frame period At has elapsed, blocks 413 through 418 are repeated and new series XFI(t+Δt) and YFI(t+Δt) are calculated. Block 422 is then repeated, and new displacements Dx and Dy are calculated in block 425. The algorithm then repeats step 428. The loop of blocks 410 through 428 is then repeated (and additional Dx and Dy values obtained) until some stop condition is reached (e.g., mouse 10 is turned off or enters an idle mode).

Although examples of carrying out the invention have been described, those skilled in the art will appreciate that there are numerous variations and permutations of the above described devices and techniques that fall within the spirit and scope of the invention as set forth in the appended claims. For example, the arms of an array need not have common pixels. It is to be understood that the subject matter defined in the appended claims is not necessarily limited to the specific features or acts described above. Rather, the specific features and acts described above are disclosed as example forms of implementing the claims. In the claims, various portions are prefaced with letter or number references for convenience. However, use of such references does not imply a temporal relationship not otherwise required by the language of the claims.

1. A motion tracking device, comprising:
a laser positioned to direct a beam at a surface moving relative to the device;
an array of photosensitive pixels positioned to receive light from the beam after the light reflects from the surface; and
a processor configured to perform steps that include
(a) calculating a series of data values representing a range of pixel intensities along a first dimension at a time t,
(b) calculating a series of data values representing a range of pixel intensities along a second dimension at the time t,
(c) calculating a series of data values representing a range of pixel intensities along the first dimension at a time t+Δt,
(d) calculating a series of data values representing a range of pixel intensities along the second dimension at the time t+Δt,
(e) determining motion along the first dimension using data from the series calculated in steps (a) and (c), and
(f) determining motion along the second dimension using data from the series calculated in steps (b) and (d).

2. The device of claim 1, wherein step (e) includes the steps of
(e1) calculating centroids for portions of the data in the series calculated in step (a),
(e2) calculating centroids for portions of the data in the series calculated in step (c), and
(e3) determining motion vectors from the centroids calculated in step (e1) to the centroids calculated in step (e2),
and wherein step (f) includes the steps of
(f1) calculating centroids for portions of the data in the series calculated in step (b),
(f2) calculating centroids for portions of the data in the series calculated in step (d), and
(f3) determining motion vectors from the centroids calculated in step (f1) to the centroids calculated in step (f2).

3. The device of claim 2, wherein step (e) includes the steps of
(e4) performing a probability analysis on the motion vectors determined in step (e3), and
(e5) determining motion along the first dimension based on the probability analysis of step (e4),
and wherein step (f) includes the steps of
(f4) performing a probability analysis on the motion vectors determined in step (f3), and
(f5) determining motion along the second dimension based on the probability analysis of step (f4).

4. The device of claim 1, wherein step (e) includes the steps of
(e1) calculating a reference value based on the series of data values calculated in step (a),
(e2) calculating crossing points for the series of data values calculated in step (a) relative to the reference value calculated in step (e1),
(e3) calculating a reference value based on the series of data values calculated in step (c), and
(e4) calculating crossing points for the series of data values calculated in step (c) relative to the reference value calculated in step (e3),
and wherein step (f) includes the steps of
(f1) calculating a reference value based on the series of data values calculated in step (b),
(f2) calculating crossing points for the series of data values calculated in step (b) relative to the reference value calculated in step (f1),
(f3) calculating a reference value based on the series of data values calculated in step (d), and
(f4) calculating crossing points for the series of data values calculated in step (d) relative to the reference value calculated in step (f3).

5. The device of claim 4, wherein step (e) includes the steps of
(e5) determining motion vectors from crossing points calculated in step (e2) to crossing points calculated in step (e4),
(e6) performing a probability analysis on the motion vectors determined in step (e5), and
(e7) determining motion along the first dimension based on the probability analysis of step (e6),
and wherein step (f) includes the steps of
(f5) determining motion vectors from crossing points calculated in step (f2) to crossing points calculated in step (f4),
(f6) performing a probability analysis on the motion vectors determined in step (f5), and
(f7) determining motion along the second dimension based on the probability analysis of step (f6).

6. The device of claim 1, wherein step (e) includes the steps of
(e1) calculating, for each of multiple different values of delay and advancement, a series of data values based on the data values in the series calculated in step (a),
(e2) comparing the series calculated in step (c) with each of the series calculated in step (e1), and
(e3) determining motion along the first dimension based on the comparisons of step (e2),
and wherein step (f) includes the steps of
(f1) calculating, for each of multiple different values of delay and advancement, a series of data values based on the data values in the series calculated in step (b),
(f2) comparing the series calculated in step (d) with each of the series calculated in step (f1), and
(f3) determining motion along the second dimension based on the comparisons of step (f2).

7. The device of claim 6, wherein
step (e2) includes calculating a correlation coefficient for each comparison of the series calculated in step (c) with a series calculated in step (e1),
step (e3) includes identifying a value of delay or advancement corresponding to a highest of the correlation coefficients calculated in step (e2),
step (f2) includes calculating a correlation coefficient for each comparison of the series calculated in step (d) with a series calculated in step (f1), and
step (f3) includes identifying a value of delay or advancement corresponding to a highest of the correlation coefficients calculated in step (f2).

8. The device of claim 1, wherein
step (a) includes the step of (a1) summing, for each of a first plurality of locations along the first dimension, data corresponding to pixel outputs from a subset of the pixels in the array corresponding to that location,
step (a) further includes the step of (a2) filtering sums generated in step (a1),
step (b) includes the step of (b1) summing, for each of a second plurality of locations along the second dimension, data corresponding to pixel outputs from a subset of the pixels in the array corresponding to that location,
step (b) further includes the step of (b2) filtering sums generated in step (b 1),
step (c) includes the step of (c1) summing, for each of the first plurality of locations along the first dimension, data corresponding to pixel outputs from the subset of the pixels in the array corresponding to that location,
step (c) further includes the step of (c2) filtering sums generated in step (c1), step (d) includes the step of (d1) summing, for each of the second plurality of locations along the second dimension, data corresponding to pixel outputs from the subset of the pixels in the array corresponding to that location, and
step (d) further includes the step of (d2) filtering sums generated in step (d1).

9. The device of claim 8, wherein
step (a) further includes the step of (a3) adding data values by interpolation of the sums filtered in step (a2),
step (b) further includes the step of (b3) adding data values by interpolation of the sums filtered in step (b2),
step (c) further includes the step of (c3) adding data values by interpolation of the sums filtered in step (c2), and
step (d) further includes the step of (d3) adding data values by interpolation of the sums filtered in step (d2).

10. The device of claim 1, wherein
step (a) includes the step of (al) summing, for each of a first plurality of locations along the first dimension, data corresponding to pixel outputs from a subset of the pixels in the array corresponding to that location,
step (a) further includes the step of (a2) adding data values to the series of step (a1) by interpolation,
step (b) includes the step of (b1) summing, for each of a second plurality of locations along the second dimension, data corresponding to pixel outputs from a subset of the pixels in the array corresponding to that location,
step (b) further includes the step of (b2) adding data values to the series of step (b1) by interpolation, step (c) includes the step of (c1) summing, for each of the first plurality of locations along the first dimension, data corresponding to pixel outputs from the subset of the pixels in the array corresponding to that location,
step (c) further includes the step of (c2) adding data values to the series of step (c1) by interpolation,
step (d) includes the step of (d1) summing, for each of the second plurality of locations along the second dimension, data corresponding to pixel outputs from the subset of the pixels in the array corresponding to that location, and
step (d) further includes the step of (d2) adding data values to the series of step (d1) by interpolation.

11. A motion tracking device, comprising:
a laser positioned to direct a beam at a surface moving relative to the device;
an array of photosensitive pixels positioned to receive light from the beam after the light reflects from the surface, the array including
a first arm including a first sub-array, the first sub-array having a size of m pixels in a direction generally parallel to a first dimension and n pixels in a direction generally perpendicular to the first dimension, where m and n is each greater than 1,
a second arm including a second sub-array, the second sub-array having a size of M pixels in a direction generally parallel to a second dimension and N pixels in a direction generally perpendicular to the second dimension, where M and N is each greater than 1, and
a pixel-free region between the first and second arms, the pixel-free region being larger than a square having sides equal to the average pixel pitch within the first and second arms; and
a processor configured to calculate movement in the first and second dimensions based on data generated from output of the pixels in the first and second sub-arrays.

12. The device of claim 11, wherein the device is a computer mouse, and further comprises
a housing, the housing including an outer surface configured for contact with and movement across the surface, the housing further including a tracking region in the outer surface through which light may be transmitted from the laser to a work surface, and wherein the processor is configured to perform steps that include
(a) calculating a series of data values representing a range of pixel intensities in the first sub-array along the first dimension at a time t,
(b) calculating a series of data values representing a range of pixel intensities in the second sub-array along the second dimension at the time t,
(c) calculating a series of data values representing a range of pixel intensities in the first sub-array along the first dimension at a time t+Δt,
(d) calculating a series of data values representing a range of pixel intensities in the second sub-array along the second dimension at the time t+Δt,
(e) determining motion along the first dimension using data from the series calculated in steps (a) and (c), and
(f) determining motion along the second dimension using data from the series calculated in steps (b) and (d).

13. The device of claim 12, wherein
step (a) includes the step of summing, for each of m locations along the first dimension, data corresponding to pixel outputs at time t from a subset of n pixels in the first sub-array corresponding to that location, thereby generating m first dimension time t sums,
step (b) includes the step of summing, for each of M locations along the second dimension, data corresponding to pixel outputs at time t from a subset of N pixels in the second sub-array corresponding to that location, thereby generating M second dimension time t sums,
step (c) includes the step of summing, for each of the m locations along the first dimension, data corresponding to pixel outputs at time t+Δt from the subset of n pixels corresponding to that location, thereby generating m first dimension time t+Δt sums, and
step (d) includes the step of summing, for each of the M locations along the second dimension, data corresponding to pixel outputs at time t+Δt from the subset of N pixels corresponding to that location, thereby generating M second dimension time t+Δt sums.

14. The device of claim 13, wherein
step (a) includes the steps of filtering and interpolating the m first dimension time t sums,
step (b) includes the steps of filtering and interpolating the M second dimension time t sums,
step (c) includes the steps of filtering and interpolating the m first dimension time t+Δt sums, and
step (d) includes the steps of filtering and interpolating the M second dimension time t+Δt sums.

15. The device of claim 12, wherein step (e) includes the steps of
(e1) calculating centroids for portions of the data in the series calculated in step (a),
(e2) calculating centroids for portions of the data in the series calculated in step (c), and
(e3) determining motion vectors from the centroids calculated in step (e1) to the centroids calculated in step (e2),
and wherein step (f) includes the steps of
(f1) calculating centroids for portions of the data in the series calculated in step (b),
(f2) calculating centroids for portions of the data in the series calculated in step (d), and
(f3) determining motion vectors from the centroids calculated in step (f1) to the centroids calculated in step (f2).

16. The device of claim 12, wherein step (e) includes the steps of
(e1) calculating a reference value based on the series of data values calculated in step (a),
(e2) calculating crossing points for the series of data values calculated in step (a) relative to the reference value calculated in step (e1),
(e3) calculating a reference value based on the series of data values calculated in step (c), and
(e4) calculating crossing points for the series of data values calculated in step (c) relative to the reference value calculated in step (e3),
and wherein step (f) includes the steps of
(f1) calculating a reference value based on the series of data values calculated in step (b),
(f2) calculating crossing points for the series of data values calculated in step (b) relative to the reference value calculated in step (f1),
(f3) calculating a reference value based on the series of data values calculated in step (d), and
(f4) calculating crossing points for the series of data values calculated in step (d) relative to the reference value calculated in step (f3).

17. The device of claim 12, wherein step (e) includes the steps of
(e 1) calculating, for each of multiple different values of delay and advancement, a series of data values based on the data values in the series calculated in step (a),
(e2) comparing the series calculated in step (c) with each of the series calculated in step (e1), and
(e3) determining motion along the first dimension based on the comparisons of step (e2),
and wherein step (f) includes the steps of
(f1) calculating, for each of multiple different values of delay and advancement, a series of data values based on the data values in the series calculated in step (b),
(f2) comparing the series calculated in step (d) with each of the series calculated in step (f1), and
(f3) determining motion along the second dimension based on the comparisons of step (f2).

18. The device of claim 11, wherein the processor comprises means for determining motion along the first and second dimensions between times t and t+Δt based on centroids of data corresponding to pixel outputs at times t and t+Δt.

19. The device of claim 11, wherein the processor comprises means for determining motion along the first and second dimensions between times t and t+Δt based on crossing points of data corresponding to pixel outputs at times t and t+Δt.

20. The device of claim 11, wherein the processor comprises means for determining motion along the first and second dimensions between times t and t+Δt based on correlating data corresponding to pixel outputs at time t+Δt with advanced and delayed versions of data corresponding to pixel outputs at time t.
